(19) United States
(12) Patent Application Publication
(10) Pub. No.: US 2013/0166457 A1
(43) Pub. Date: Jun. 27, 2013

(54) MANAGED BRAND FEEDBACK SYSTEM

(71) Applicants: Ying DU, Kanata (CA); Ronald RICHARDSON, Kanata (CA)

(72) Inventors: Ying DU, Kanata (CA); Ronald RICHARDSON, Kanata (CA)

(73) Assignee: BENBRIA CORPORATION, Ottawa (CA)

(21) Appl. No.: 13/332,481

(22) Filed: Dec. 21, 2011

(51) Int. Cl. G06Q 30/00; G06Q 50/00

(52) U.S. Cl. CPC G06Q 30/01; G06Q 50/01
USPC 705/304

(57) ABSTRACT

Systems and methods for managing feedback from customers, especially feedback which has been posted on social media websites or submitted electronically from a mobile device. Specific social media websites are automatically monitored for comments regarding a specific brand. Customers who posted comments are contacted with an invitation to provide more details regarding the comment. A link to the brand's website or to a specific feedback application is provided to the customer. Once the customer logs in to either the website or the application, the customer can provide more details regarding the comment and this feedback is assigned a ticket. The feedback associated with the ticket is then routed based on the content of the feedback.

### TECHNICAL FIELD

The present invention relates to brand public relations management. More specifically, the present invention relates to methods and systems for receiving and managing customer feedback.

### BACKGROUND OF THE INVENTION

The Internet revolution of the past decade and the social media explosion of the past few years have changed how customers provide feedback for products and services that they buy.

Current feedback systems generally include customers contacting the company associated with a brand and providing usually unsolicited feedback regarding the service or product associated with that brand. The contact may be made by way of a phone call, an email, comments submitted on paper, or by posting information through an on-line web form. The feedback is then received by a call or contact center team at the company. The feedback is then logged, reported, and then transferred by an agent of the call center. The information regarding the feedback is transferred to the appropriate personnel or department.

Unfortunately, these current feedback systems have a number of drawbacks. In these feedback systems, the customer or user is not in direct contact with the appropriate personnel or department. Furthermore, this feedback process does not allow for a dialogue between the user and the company managing the brand. Often times, the customer who placed the original call will never get a return call or any follow-up information from the company managing the brand. For example, if a customer of a restaurant chain wants to provide feedback related to a specific location for that restaurant chain, the customer can call a central location and place his complaint/comment, but the customer does not speak directly to the manager for that specific location. Even if the feedback reaches the manager for the specific restaurant location, the customer will likely never receive a return message. The customer will therefore never know what has happened to the feedback provided and this may discourage people from providing meaningful feedback in the future. Alternatively, if the restaurant manager does contact the customer, this communication is often untracked, invisible, and possibly unknown to the company managing the brand.

The advent of the social media revolution has seen customers increasingly turning to social media web sites to post their comments (positive or negative) regarding their experiences with a brand. Brand representatives or organizations have difficulty managing these comments and the potential spread of negative information. At the other end of the spectrum, positive comments are similarly not directed back to the company managing the brand or to store locations to which the feedback pertains. Such positive comments can be useful in boosting employee morale at the company or in validating what the company is doing right. Companies managing brands today will employ strategies to ‘monitor’ social media, and, in select cases, will provide generic responses such as directing customers specifically to contact the call center, providing generic apologies, or offering coupons or other incentives in an attempt to remedy the symptom of the problem (e.g. an unhappy customer) rather than the root cause (e.g. problem within the business). These companies do not employ effective systems or methodologies which adequately organize feedback over social media. Mobile or online-based customer feedback is not available to staff in the field nor are staff given the ability to respond to such comments. There is no mechanism for customers to engage with field staff over mobile, SMS, social media, and similar forms of communication.

There is therefore a need for a system to manage feedback for a brand or an organization beyond the call/contact center and to involve field staff in that engagement.

### SUMMARY OF INVENTION

The present invention provides systems and methods for managing feedback from customers, especially feedback which has been posted on social media websites or which has been submitted electronically from a mobile device. Specific social media websites are automatically monitored for comments regarding a specific brand. Once a comment regarding that brand is detected, the customer who posted the comment is contacted with an invitation to provide more details regarding the comment. A link to the brand's website or to a specific feedback application is provided to the customer. Once the customer logs in to either the website or the application, the customer can provide more details regarding the comment and this feedback is assigned a ticket. The feedback associated with the ticket is then routed based on the content of the feedback—the feedback can be responded to automatically or it can be routed to a brand manager/representative who can respond to the customer directly. The customer may be contacted using his or her communications channel of choice.

In a first aspect, the present invention provides a method for managing customer feedback, the method comprising:

a) monitoring at least one website for comments regarding at least one predetermined identifier;

b) detecting a comment regarding said identifier;

c) extracting said comment including information relating to a customer who posted said comment;

d) creating a temporary ticket relating to said comment;

e) transmitting a link to said temporary ticket to said customer;

f) creating a feedback ticket once said customer activates said link;

g) receiving contextual information from said customer regarding said identifier, said customer providing said contextual information by activating said link, said comment and said contextual information being associated with said feedback ticket;

h) retrieving routing data relating to said comment;

i) routing said comment and said feedback ticket based on said routing data;

j) determining a type of response to said comment;

k) creating a response to said comment; and

l) sending said response to said user.

In a second aspect, the present invention provides a method for managing customer feedback, the method comprising:

a) monitoring a website for comments regarding at least one specific brand;

b) extracting comments regarding said at least one specific brand from said website;

c) forwarding extracted comments to at least one brand representative for a response to said comment; and

d) forwarding said response to a customer who originally posted said comment.

In a third aspect, the present invention provides a system for managing customer feedback, the system comprising:
a monitoring module for monitoring at least one website for comments regarding at least one predetermined identifier;
a comment extraction module for extracting said comments from said at least one website;
a communications module for communicating with at least one customer who posted said comments;
a routing module for routing said comments and a feedback ticket associated with said comments based on routing data.

### BRIEF DESCRIPTION OF THE DRAWINGS

The drawings show features and advantages which will become more apparent from a detailed consideration of the invention when taken in conjunction with the drawings in which:

FIG. 1 shows a configuration where a social media monitoring function is used to trigger a feedback application;

FIG. 1A illustrates a system configuration upon which aspects of the invention may be practiced;

FIG. 2 shows a single user interaction with the feedback application;

FIG. 2A illustrates the steps executed for a brand representative to manage and view routing configuration tables;

FIG. 2B illustrates the logic flow followed when aggregating tickets relating to similar issues;

FIG. 3A illustrates the logic flow for a feedback ticket routing;

FIG. 3B depicts the logic flow used when sending a notification to a contact;

FIG. 4 illustrates a flow diagram involving a feedback loop with multiple users and social media sites;

FIG. 5 is a flow diagram for a brand representative interaction with feedback loops involving multiple users.

### DETAILED DESCRIPTION OF THE INVENTION

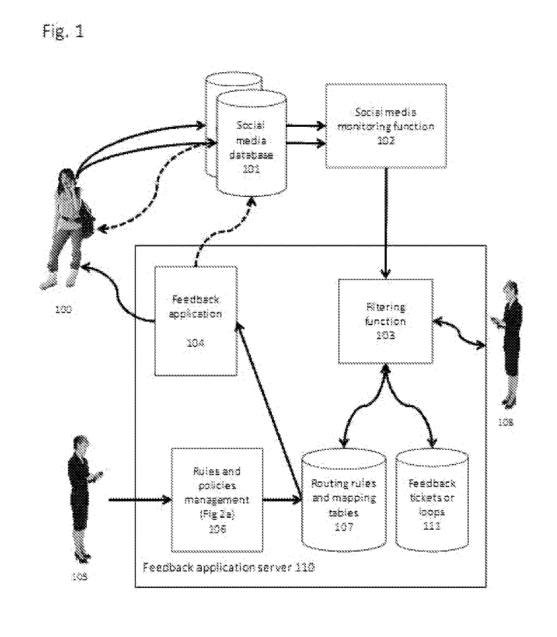

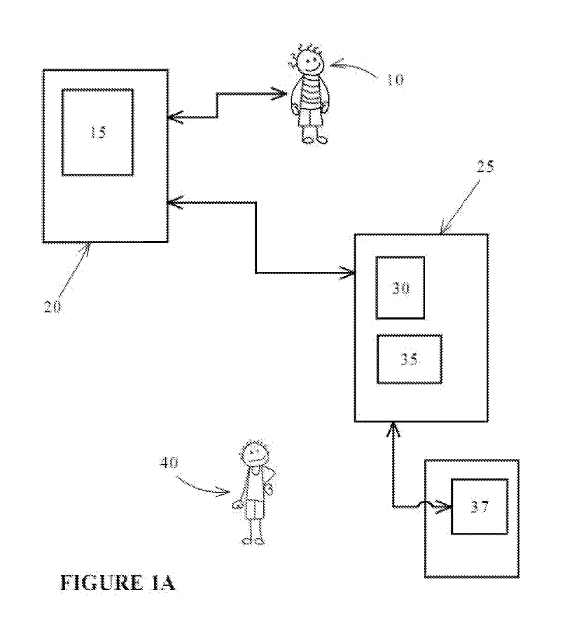

Referring to FIG. 1A, a system on which the invention may be implemented is illustrated. A customer 10 posts a comment regarding a brand on a social media website 15 that operates from a social media server 20. A monitoring server 25 monitors the social media website 15 and, when the comment from the customer 10 is detected, an invitation is sent to the customer 10. The invitation causes the customer 10 to login/access the brand server 25 which provides the customer 10 with an opportunity to expand on the comment by adding more information regarding the customer's experience with the brand. The expanded information as well as the content of the original comment thus creates a feedback 30. The creation of the feedback 30 creates a ticket 35 that is associated with the feedback 30. The brand server 25 retrieves routing data 37 based on the content of the feedback 30. The feedback 30 and its associated ticket 35 are then routed based on the routing data 37. A brand representative 40 may, depending on the content of the feedback 30, receive the feedback 30 so that a suitable response can be formulated. Once the response is created, it is then sent to the customer 10. Depending on the content of the feedback, the brand representative may adjust the routing of the feedback to other brand representatives or to other possible recipients. It should be noted that the monitoring server functions and the brand server functions may be taken on by a single server. Alternatively, separate servers may take on these separate but related functions.

Referring to FIG. 1, a flow diagram illustrating one aspect of the invention is shown. In FIG. 1, a customer 100 posts a comment on a social media website 101 (e.g. Facebook™, Twitter™, Yelp™) relating to a brand. The brand or predetermined identifier may refer to a service, a product, an organization, a company, or a location for a chain of stores or businesses. The brand (also referred to as a predetermined identifier) may be a registered or non-registered trademark or any type of identifier generally associated with a specific business, organization, product, service, or company. The monitoring server 25 uses a social media monitoring (SMM) function or program 102 to read through all the postings to detect postings that are related to a specific brand registered with a feedback application server 110. A filtering function 103 which can extract relevant postings and comments can be combined with the SMM or can be implemented separately with the filtering function's input being retrieved from the output of the SMM.

The filtering function can implement one or more mechanisms to extract relevant postings. One mechanism which may be used is Natural Language Processing (NLP) for first pass detection: NLP mechanisms are trained on what constitutes positive comments, negative comments, and irrelevant information in relation to a particular brand. The comments that pass the initial filter may be further classified by a human 108 to ensure the accuracy of the detection. The classification from the human 108 can become input to an NLP engine to further improve the accuracy of its processing.

Another mechanism that may be implemented as part of the filtering function 103 is used to perform keyword lookup and expression matching on the content of the comments detected on the various social media websites. For example, the filtering function could be looking for posts with “complaint” and “restaurant ABC” or posts with “dirt” and “store XYZ”. Similarly, expression patterns or ‘soft matches’ can be used to account for variations in language as in “b+a+d+” being a regular expression used to identify deliberately misspelled words like “bbbaaaaddd”. The mechanism used as part of the filtering function may contain a vocabulary and a rating dictionary of words, patterns, and rules that is updated and improved over time either automatically by learning mechanisms or manually by human intervention.

Another mechanism that can also be used by the filtering function 103 would determine the influence of the comment or the influence of the customer who posted that comment. This can be done by performing API calls to social reputation engines such Klout™. This may also be done by determining how many times a particular comment is re-shared, reposted and/or ‘retweeted’ within, as examples, the first 10 minutes or 30 minutes. Clearly, the more times a comment is shared or reposted, then the higher is the potential influence of that comment. This may also be done by determining the fan-out or size of the online following, network, and/or audience of a customer.

The filtering function 103 may also extract user location data from messages and/or comments shared on social networking websites. For messages that have location data attached, the location information can be extracted and compared against a list of known locations that are related to specific brands. The messages that are listed as being in very close geographic proximity to such known locations can be marked as being related to the brand or as being relevant messages to the brand.

The output of each of the mechanisms described above can be used independent of one another or can be used as an aggregated combination using weighted sums or any similar method. A final result, arrived at using either the outputs independently or using a weighted and aggregated measure of all the outputs, is stored in the feedback application server 110 and used by the feedback application to identify the appropriate system response to a social media message.

Along with the content of the comment, contact information relating to the customer 100 who originated the comment is extracted (if available) from the social media website. A temporary feedback ticket associated with the comment is created along with a link to the newly created ticket. The link 104 to the newly created ticket is sent back to the customer 100 over the channel where the original comment was originally encountered. As an example, if the comment was detected on the Twitter microblogging/social networking service, a link containing the temporary ticket is sent back to the originator of the “tweet” or comment on Twitter. Alternatively, the link can be sent to the customer 100 via email or SMS if such contact information is available through the feedback message. It should be noted that activating the link will effectively invite the customer to expand on the content of the comment posted on the social networking website. Once activated, the link will bring the customer to a website for the named brand or will activate the feedback application 201. The customer 100 can then provide more information beyond the initial comment.

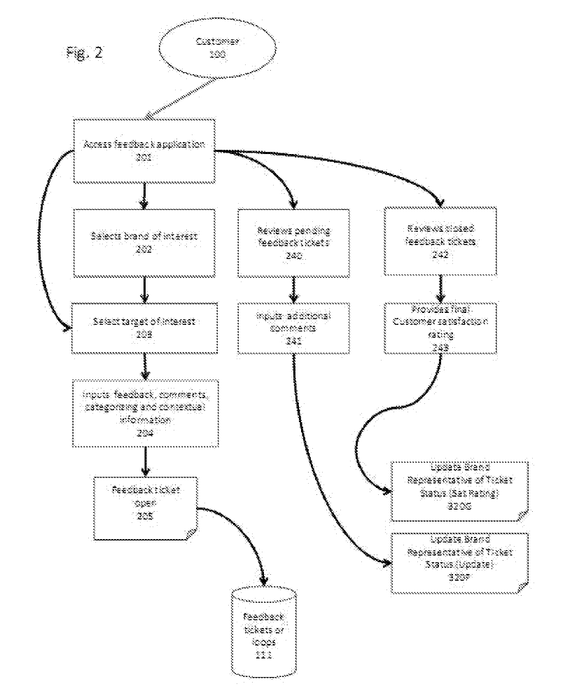

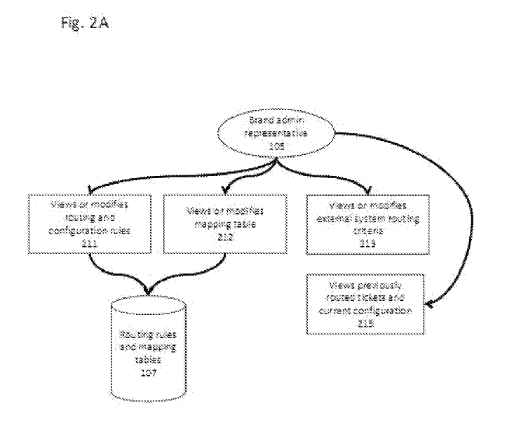

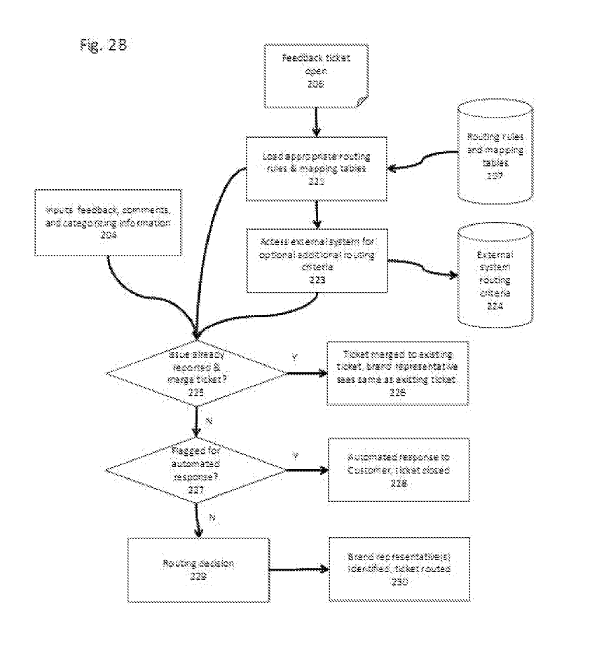

Referring to FIG. 2, the customer 100 is referred to and accesses the feedback application 201 in one of many ways, including but not limited to the following:
by manually entering a URL in a web browser, or
through a link 104 provided as a QR-code (physically 2D scanned barcode) or similar, or
through a link advertised online, or
through a link shared by another customer (e.g. a friend of customer 100) online and/or over social media, or
through a physical device such as an in-store or mobile kiosk, or
as an embedded link as a feature of an existing mobile application or website, or
as a downloaded and installed application on a device used by the customer, or
as an application used by an brand employee on behalf of the customer 100, or
other means or methods of access as permissible by technology or design.

The mobile application or website may, of course, originate or be managed by a company managing the brand to which the customer's original comment relates. Depending on the implementation, access to the feedback application 201 may require account setup, user authentication, and login. Regarding the feedback application 201, upon registration, the customer may create an account to provide basic information such as his/her name, email address, mobile phone number, and other details as appropriate, including contact information and the customer's preferred communications channel (e.g. email, telephone, posting on a social media website). In addition to personal and demographic information, the customer may also provide loyalty information (e.g. a customer loyalty program number), existing brand account credentials (e.g. account information for logging into websites relating to the brand), credentials for third party logins (e.g. Facebook™, Twitter™, etc.), other information that would allow entities related to the brand to offer a superior service or product to that customer, other information which can be used to determine the urgency of the customer's issues, or other information which can be used to measure the importance or prestige or reputation of the customer to the brand (loyalty, status, past history, etc.).

Once the customer has access to the feedback application, either the customer selects the brand of interest 202 (or the right organization, e.g. “restaurant ABC”) or the brand of interest is automatically populated by the system. The customer is then prompted to provide additional details regarding the customer's earlier comment which the customer may have posted on the social media website or which may have been previously sent to the brand by some other means. The customer 100 may be requested to input 204 one or more of the following (not necessarily in the order outlined below):
the type of the feedback (e.g. positive experience, negative experience, suggestion)
the specific categorization of their feedback (e.g. related to food, facilities, the service, staff, the quality of the product)
additional comments either via free-form entry or pre-populated selections accessed via menu navigation relating to their feedback
additional contextual information (free-form or validated against the feedback server database) which may aid the entities managing the brand in providing resolution to the customer. This may include one or more of the following as examples:
   ‘drive-through’ or ‘in-store’ service,
   employee name,
   receipt number,
   airline flight and seat number, room number,
   customer loyalty number,
   promotion code,
   product code,
   referral code,
   store number,
   other similar contextual information which may optionally be validated against a brand's database or external system.

This additional contextual information can be used to, for example,
affect the routing of tickets and their associated feedback
assist in the speed of resolution of the issue,
provide loyalty incentives to the customer,
issue rewards to the customer,
link the feedback to the customer profile in the customer databases (which may be maintained by the company managing the brand), and
provide internal tracking and reporting.

Once more details have been entered regarding the customer's experience with the brand, the feedback application creates a feedback ticket 205. The input format and the number of inputs for the details to be entered by the customer can differ depending on the brand or the company managing the brand.

As an alternative to the above, the feedback application 201 may already point to a specific brand of interest if the feedback application was launched based on the SMM. As another alternative, a customer can launch an application that is branded specifically for an organization, or the customer can access a URL that is specific to a brand or an organization. Upon accessing the webpage referenced by the URL, the customer is brought to the brand's specific page within the system. Optionally, one or more targets might be defined for the brand and be made visible to the customer through the application. As examples, a restaurant franchise brand may be associated with multiple restaurant locations or a department store brand may be associated with multiple departments within that store at a particular location. These various locations or departments may then be presented to the customer so that the customer may reference his or her comment for a specific store department or a specific restaurant chain location. The customer may also be requested to select one target 203 to narrow the scope of the comment to that target.

When the feedback from a customer has been saved, the feedback (which would include the content of the comment from the social media website, optional contact information for the customer, categorization information about the type and target and similar details of the ticket, etc.) can be routed to a suitable destination for processing. One of these possible destinations is a brand representative who would then formulate a suitable response to the comment and who can ensure that the customer's issues are properly addressed. FIG. 2A presents the brand representative's 105 steps for managing and viewing the routing configuration tables used to route feedback and its associated ticket to the appropriate destination. Through the application or an external interface, the brand representative 105 is able to view or change the routing configuration and routing rules 211 (i.e. the rules for assignment of tickets based on inbound criteria) or the mapping tables 212 (mapping of brand representatives to targets and roles within the application function), which read and/or write to the system's data definition for routing and mapping tables 214. Alternatively, the brand representative 105 is able to view (and externally modify) the routing criteria gathered from external systems, and to view 213 both previously routed and assigned tickets and how the current configuration would affect new tickets through this interface 215.

Referring to FIG. 2B, upon the creation (opening) of a new ticket 206 the feedback application uses the customer-provided information 204 to identify the correct entity (individual, group, contact center team, etc.) within the brand to initially receive the ticket and feedback. Following the opening of a ticket 206, the system queries and loads 221 routing and mapping tables 214 relevant to the new ticket 206.

The system may also aggregate similar tickets into a single ticket. For this, the system optionally queries 223 a third party system 224 (belonging to the brand or other party) for additional routing criteria. Based on the system routing and mapping data 214, the optional external routing data 224, and the information supplied by the customer and stored in the ticket 206, the system may first identify if a similar ticket exists. If similar tickets exist (i.e. other tickets that relate to the same issues), the system determines if these similar tickets should be merged 225. If these similar tickets should be merged, multiple customers can be linked to an open issue 226 and all other system behaviors apply as before. Alternatively, if no similar open tickets exist, the system identifies if the issue detailed by the ticket warrants an automated response 227. If an automated response is needed, an automatic response is created and delivered to the customer over the customer's communications channel of choice 228. If the issue highlighted by the feedback requires a response other than an automated response, the system makes an intelligent routing decision 229 and identifies one or more target brand representative(s) 230 that will be initially responsible for the customer ticket 206. For tickets that resulted when multiple customer feedback comments were ‘merged’ into a single ticket 226, the customers are said to be “backing” this ticket or issue. All interactions by the company managing a brand on such a ticket are visible to all backers. Likewise, all backers are visible to the company managing that brand.

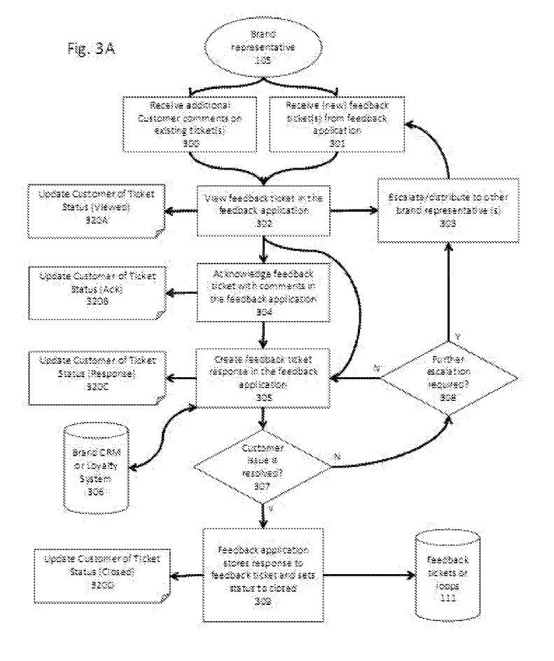

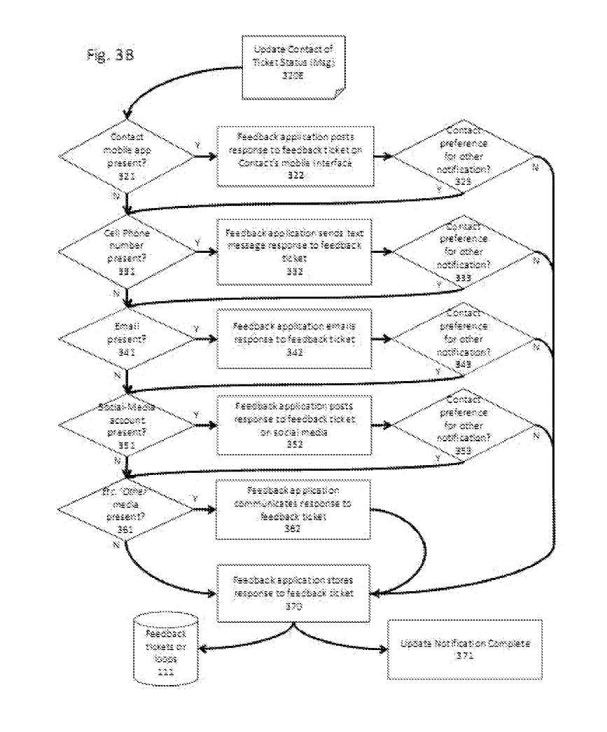

Referring to FIG. 3A, the logic flow for a feedback ticket routing is detailed. Depending on the implementation, a routing module operating from the brand server may be used. A brand representative (e.g. a restaurant manager or a store manager) 105 receives a feedback ticket through the feedback application (step 301) based on the targets selected and routing decisions made previously. Depending on the type of feedback, the priority of a ticket might be automatically or manually escalated and the ticket and its associated feedback may be distributed to one or more other brand representatives (e.g. a manager of a specific restaurant chain location) (step 303). The disposition of a ticket may also depend on the time of the day the ticket is raised, which target the ticket is filed under, the profile and importance of the original poster who started the ticket, the number of tickets that get raised in a set time span, decisions made by third party systems, and/or a combination of any of these and other factors.

Once one of the brand representatives 105 receives a feedback ticket, that brand representative 105 views that ticket through the feedback application (step 302) which, depending on system settings and preferences, may initiate an update notification of the viewed status to the customer (step 320A) (Viewed). Should the brand representative 105 choose upon viewing the ticket (step 302), the ticket may be escalated/distributed to other representatives (step 303). Should the brand representative 105 wish to acknowledge the feedback ticket (step 304) to inform the customer that the feedback has been received and reviewed, this action would initiate a notification (step 320B) (Ack) to be delivered to the customer. Once the issue noted by the feedback ticket 301 has been dealt with the brand representative 105 creates (or selects from a pre-formed menu) a response (step 305) which initiates a customer notification of ticket status (step 320C) (Response) that is delivered to the customer. The response may include different perks or rewards (such as coupons, discounts, complementary meals, complementary dishes, complementary products, etc.) that optionally may contact a third party Brand CRM or Loyalty System 306 to both request an identifier for such a perk or reward and to record the act of disseminating of said identifier for future management and reference.

The decision to ‘close’ a ticket is made upon perceived completion/closure of the reported issue and satisfaction of the customer. If the customer issue is not yet resolved (decision 307), the issue may be escalated (decision 308) to one or more other brand representatives (step 303), or, the brand representative 105 may continue and create a next feedback ticket response (step 305). Should the customer issue be resolved (decision 307), the feedback application stores the responses and sets the ticket status to closed (step 309), then triggering a ticket status update (Closed) to the Customer (step 320D). All state updates (including views, acknowledgements, responses, closures, and other information) are saved to the system database 111.

Referring to FIG. 3B, the figure depicts the logic flow when a notification is sent to an individual based on change in ticket state. For this invention, both the brand representative 105 and the customer 100 are considered ‘Contacts’ and are treated similarly. To update a contact of a ticket status (step 320E), the process begins with determining if a Contact is a registered user of a mobile handset version of the feedback application (step 321). If so, then, a response is sent as a mobile handset interface update/message (step 322) on the contact's mobile handset interface. If the Contact preferences indicate that the contact prefers to have multiple notifications, (step 323) and if a text-message capable mobile number is provided by the Contact and attached to the ticket (step 331), the response is sent as a text message to the contact (step 332). Should the Contact preferences indicate that the contact prefers other forms of notification (step 333) and an email address be present (step 341), the response is sent as an email message to the contact (step 342). Similarly, should the Contact have preference for other forms of notification (Step 343) and a social media account is present (step 351), the response is sent as post on the social media site to the contact (step 352). Step 353 determines if the Contact preferences indicate that further forms of notifications are required. In a similar fashion, the system can decide what ‘Other’ media are present and available (step 361), and can communicate to the Contact over such media (step 362). Following the communication the feedback response is then stored (step 370) in the database 111 for future retrieval by the Contact. Similarly, if any of decisions 323, 333, 343, and 353 are answered in the negative, the logic flow also moves to step 370, that of storing the response. The response is stored if no contact information is available for the Contact. Regardless of whether contact information for the Contact is available or not, the response is stored so that the customer may retrieve the response at any time. The system is notified at this point that the update notification is complete (step 371).

In should also be noted that, addition to the communications channels discussed above and detailed in the Figures (e.g. a mobile version of the feedback application, SMS, and email), the response may be sent to the customer via other communications channels. Of course, the choice of communications channels is based on the availability of these channels and the customer's preference. Such communications channels may include the social media website 101 on which the original comment was posted or other social media sites (as per step 351 and step 352). Depending on the implementation, these communications channels may be accessed through a communications module on the brand server 25.

Referring back to FIG. 2, should the Customer 100 wish to review a ticket previously created, upon accessing the feedback application (step 201) the customer may review previously created tickets pending closure (step 240) or review closed feedback tickets (step 242). In the case of a ticket pending closure, Customer 100 may input additional comments (step 241) based on the brand representative's 105 feedback ticket response (Step 305) or for other reasons. If additional comments are entered, the brand representative is notified of an update to the ticket status (step 320F) (Update). In the case of a closed ticket, the Customer 100 may provide a final customer satisfaction rating (step 243) of their experience or level of contentment with the experience. This rating may take the form of a selection of 1 through 5 stars, level of happiness ('low', ‘medium’, or ‘high’), or some other similar measure. Upon providing or changing a final customer satisfaction rating (step 243), the Brand Representative is notified of a (Sat Rating) ticket status change (step 320G).

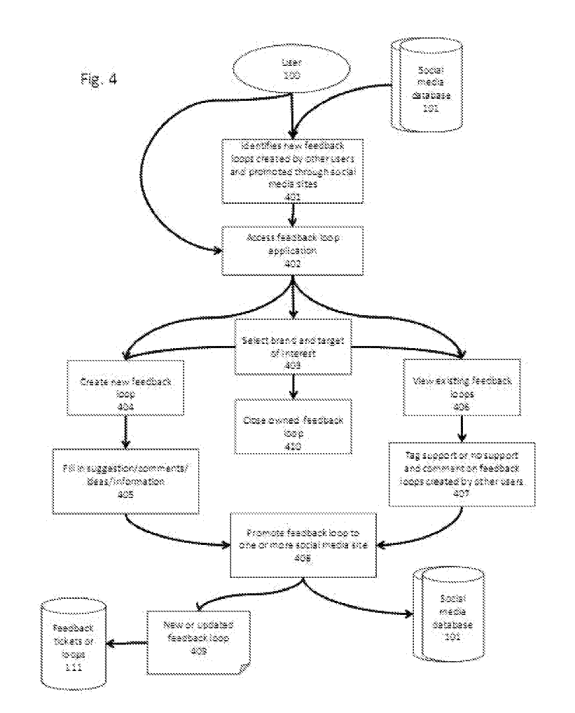

Referring to FIG. 4, a flowchart detailing steps for utilizing a feedback loop application is illustrated. A customer can access the feedback loop application by way of feedback loops posted on social media websites (step 401) by other customers. A customer can also access the feedback loop application by directly launching the application (step 402).

Once the application has been accessed, the customer can select a brand or target of interest (step 403) and create his or her own new feedback loop (step 404). The new feedback loop will have the customer entering his or her suggestions, comments, ideas, or information regarding the selected brand in the application (step 405). The comments regarding the brand can be entered in free-form or by using a pre-programmed menu. Once complete, the new feedback loop can then be promoted on one or more social media websites where other customers can register their support, approval, disapproval, or comments regarding the feedback loop (step 408).

The application can also be accessed by the customer to maintain/close that customer's previous feedback loops. In step 403, the customer selects a brand or target of interest so that the feedback loops relating to this brand or target may be accessed. The customer may then close any or all of his or her own feedback loops relating to the brand or target of interest (step 410).

A third option for the customer is to use the application to provide his or her own comments regarding pre-existing feedback loops. Once the application has been accessed, the customer can select a brand or target of interest. Once this is done, the customer can view existing feedback loops (step 406) created by other customers for the selected brand. The customer can then leave comments, render his or her support for the feedback loop, or otherwise render his approval or disapproval of any of the pre-existing feedback loops (step 407). Once this is done, the feedback loops which have been commented on can be promoted on one or more social media websites (step 408).

It should be noted that access to the application may require account creation, authentication and/or login. The customer may also find feedback loops via real-world QR codes (“Quick Response” code or synonymous with 2D Barcodes) or links found in printed materials. The customer can access these existing loops via the feedback application 402.

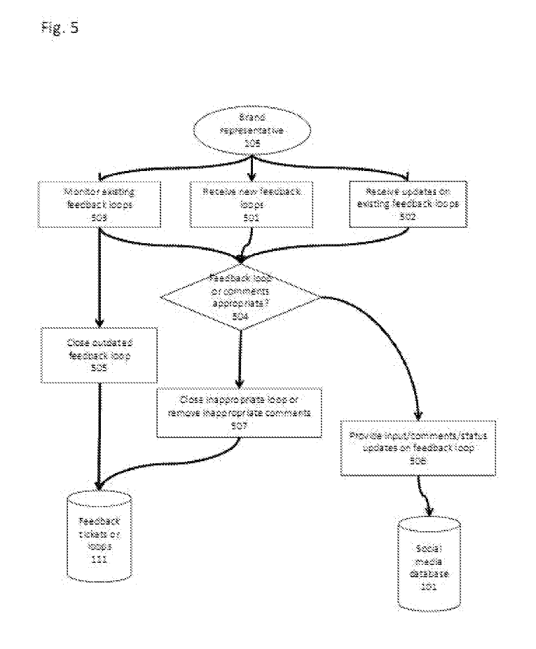

Referring to FIG. 5, a flowchart detailing the steps involved when a brand representative deals with feedback loops is illustrated. The brand representative 105 can monitor any existing feedback loops (step 503). Outdated feedback loops can be closed down by the brand representative (step 505). The representative can also receive new feedback loops (step 501) or receive updates on existing feedback loops (step 502). For the new or non-outdated feedback loops, the brand representative analyzes the content of the loops and its associated comments. If the feedback loop or comments regarding the feedback loop are inappropriate (step 504), the brand representative can close down the feedback loop or remove the inappropriate comments (step 507). If there is no inappropriate content associated with either the comments or the feedback, the brand representative can provide status updates, comments, or input for the feedback loop (step 506). This representative provided content can then be reposted on the social media website where the feedback loop originated.

It should be noted that for inappropriate content in either the feedback loop or the comments, the brand representative can optionally provide comments directly to the originator of the inappropriate content prior to shutting down the feedback loop or deleting the inappropriate content. As an alternative to reviewing all the feedback loop content, the brand representative might only monitor/gather the comments provided by the different users accessing the feedback loop 506. The brand representative may, when appropriate, add comments to the feedback loop. The commented feedback loops can then be propagated to the different social media sites that are posting the loop 506.

Regarding the comments provided by the brand representative, the interface designed to allow the brand representative to provide comments 506 is capable of ‘smart’ responses that are optionally customized for the brand. The predetermined responses may be available in a quick-select (drop-down or list or similar fashion) interface, and the system can automatically populate the editable response to the customer with such items as the message content, the customer's name or other details, the date and/or time, a reference number for tracking purposes, and other information which can be then manually edited or appended to by the brand representative before sending.

Different types of reports can be generated from the feedback loops or feedback tickets managed. Those reports can be customized to parse the information for specific purpose.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method for managing customer feedback, the method comprising:
a) monitoring at least one website for comments regarding at least one predetermined identifier;
b) detecting a comment regarding said identifier;
c) extracting said comment including information relating to a customer who posted said comment;
d) creating a temporary ticket relating to said comment;
e) transmitting a link to said temporary ticket to said customer;
f) creating a feedback ticket once said customer activates said link;
g) receiving contextual information from said customer regarding said identifier, said customer providing said contextual information by activating said link, said comment and said contextual information being associated with said feedback ticket;
h) retrieving routing data relating to said comment;
i) routing said comment and said feedback ticket based on said routing data;
j) determining a type of response to said comment;
k) creating a response to said comment; and
l) sending said response to said user.

2. A method according to claim 1 wherein said response is an automatically generated response.

3. A method according to claim 1 wherein said response is manually created.

4. A method according to claim 1 wherein said information relating to said customer includes contact information for said user.

5. A method according to claim 1 wherein said comment is filtered to determine which comments are to receive an automatically generated response.

6. A method according to claim 1 wherein said feedback is filtered such that comments regarding similar issues are aggregated under a common feedback ticket.

7. A method according to claim 1 wherein step i) includes adjusting a routing of said feedback based on a content of said comment.

8. A method according to claim 7 wherein said feedback is routed based on an urgency of an issue contained in said comment.

9. A method according to claim 1 wherein said feedback is routed to at least one brand representative for responding to said comment.

10. A method according to claim 1 wherein each response is assigned a reference number.

11. A method according to claim 10 wherein a representative responding to said comment assigns a reward for said comment, said reward being sent to said customer who posted said comment.

12. A method according to claim 11 wherein said reward comprises at least one of:
coupons
discounts
complementary meals
complementary dishes
complementary products

13. A method according to claim 1 wherein said response is sent to said user using said information extracted in step c).

14. A method for managing customer feedback, the method comprising:
a) monitoring a website for comments regarding at least one specific brand;
b) extracting comments regarding said at least one specific brand from said website;
c) forwarding extracted comments to at least one brand representative for a response to said comment; and
d) forwarding said response to a customer who originally posted said comment.

15. A method according to claim 14 wherein step d) comprises posting said response to said website.

16. A method according to claim 14 wherein step d) comprises sending said response directly to said customer.

17. A method according to claim 16 wherein said response is sent to said customer using at least one of said communications channels:
text messaging
email
at least one social media website
a mobile application

18. A method according to claim 14 wherein said website is a social media website.

19. A method according to claim 14 wherein step c) comprises
retrieving routing data based on content of said comment;
routing said comment to said at least one brand representative based on said routing data.

20. Computer readable media having encoded thereon computer readable and executable instructions for executing a method for managing customer feedback, the method comprising:
a) monitoring a website for comments regarding at least one specific brand;
b) extracting comments regarding said at least one specific brand from said website;
c) forwarding extracted comments to at least one brand representative for a response to said comment; and
d) forwarding said response to a customer who originally posted said comment.

21. A system for managing customer feedback, the system comprising:
a monitoring module for monitoring at least one website for comments regarding at least one predetermined identifier;
a comment extraction module for extracting said comments from said at least one website;
a communications module for communicating with at least one customer who posted said comments;
a routing module for routing said comments and a feedback ticket associated with said comments based on routing data.
